(19) United States
(12) Patent Application Publication
(10) Pub. No.: US 2011/0046944 A1
(43) Pub. Date: Feb. 24, 2011

(54) PLAIN ENGLISH DOCUMENT TRANSLATION METHOD

(76) Inventor: Kathryn Sparks, East Strousburg, PA (US)

Correspondence Address: HOFFMANN & BARON, LLP, 6900 JERICHO TURNPIKE, SYOSSET, NY, 11791, US

(21) Appl. No.: 12/860,434

(22) Filed: Aug. 20, 2010

Related U.S. Application Data
(60) Provisional application No. 61/235,444, filed on Aug. 20, 2009.

(51) Int. Cl. G06F 17/27

(52) U.S. Cl. 704/9

(57) ABSTRACT

A method for building a plain English guide containing translations of a complex document is provided. The method begins by creating a working template from an electronic copy of the complex document using a computing device. Next, the method displays the working template on a user interface connected to the computing device. After that, the method performs one or more translation actions. Then, the method selects one of a set of custom icons after performing each of the translation actions. Finally, the method produces the plain English guide using the computing device to generate a report.

### CROSS-REFERENCE TO RELATED APPLICATION

This application claims the benefit of U.S. Provisional Application No. 61/235,444, filed Aug. 20, 2009, the contents of all of which are incorporated by reference herein.

### FIELD OF THE INVENTION

The present invention is directed to a method for providing translations of complex documents. More specifically, the present invention provides a method for building a plain English guide containing translations of complex documents.

### BACKGROUND

In everyday life we encounter many documents that are not written in plain English. These documents include legal documents, insurance policies, banking agreements, and healthcare policies to name a few. The documents may be frustrating to read because of the legal terminology and industry language that tends to obstruct important information.

After reading and extensively reviewing such a document, one may think they comprehend the document, yet feel uncertain because of the complex wording. Even more troublesome, the reader may come away with an incorrect impression of the contents of the document. Furthermore, one may remain uncertain or concerned even after a lawyer or the preparer explains the document. Therefore, there is a need for providing a plain English translation guide to assist in understanding these documents and facilitate an intelligent conversation with an attorney or document preparer.

### SUMMARY

According to aspects illustrated herein, there is provided a method for building a plain English guide containing translations of a complex document. The method begins by creating a working template from an electronic copy of the complex document using a computing device. The template includes at least one original document section and a translation section corresponding to each of the at least one original document sections. The original document section contains a portion of the complex document. The translation section contains a blank text box. Next, the method displays the working template on a user interface connected to the computing device. After that, the method performs one or more translation actions, the translation actions are selected from the group consisting of: searching the original document section for all industrial terminologies in the original document section; inserting, in the translation section, a definition as a representation of each of the industrial terminologies; searching the original document section for all terms of art in the original document section; and inserting, in the translation section, a plain English representation of each of the terms of art. Then, the method selects one of a set of custom icons after performing each of the translation actions, the custom icons symbolizing the translation action performed. Finally, the method produces the plain English guide using the computing device to generate a report containing the at least one original document section adjacent to the at least one translation section and arranging the custom icon adjacent to each pair of the original document and translation sections.

### BRIEF DESCRIPTION OF DRAWINGS

FIG. 1 shows a block diagram of the method of the present invention for building a plain English guide.

FIG. 2 provides a representation of a screenshot of a working template with an original document section and a translation document section.

FIG. 3A provides an example of the cover page of the plain English guide document.

FIG. 3B provides an example of a plain English guide document.

FIG. 3C provides a further example of a plain English guide document.

FIG. 4 is a block diagram of an example of the customer's view of the process.

FIG. 5 is a block diagram of an example of a method for building a plain English guide using software to automate the process.

### DETAILED DESCRIPTION

A method for translating complex documents into plain English is provided herein.

As used herein, the term “complex document” refers to documents and/or agreements written by an attorney and/or one in the industry that contains legal terminology and/or industrial terminology including the use of archaic language that is difficult to understand. Examples include, but are not limited to, legal documents, medical policies, sports and entertainment documents, loan documents, real estate documents, child support papers, insurance policies, court records and charges, healthcare terminology, employment documents, wills, foreclosure documents, vendor contracts, and business partnerships.

As used herein, the term “custom icon” is an image displayed on a plain English guide and/or a wizard/software program that represents the type of action performed on one or more portions of the complex document. The custom icon may be added as a bullet to the plain English guide and/or translation section, or the custom icon may be selected automatically or manually using a software program.

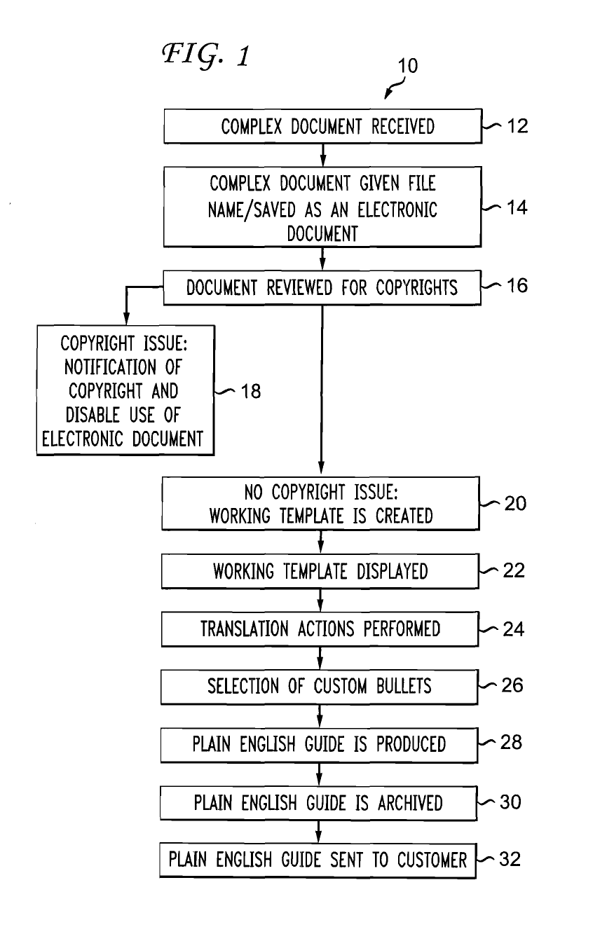

Referring to FIG. 1, a method 10 for building a plain English guide is set forth. As depicted in step 12, a complex document is received by a computing device. The computing device may be operatively attached to a server for document translation and/or interpretation. In a further embodiment, the computing device may include document translation software.

It is preferred that the complex document is submitted and received by the computing device electronically using a secure connection that requires clients to login via a web portal. However, the complex document may be received via email, mail, or by any other electronic means as may be appreciated by one skilled in the art. After that, as depicted in step 14, the complex document may be given a file name and/or saved as an electronic document to a server or database.

Next, in step 16, the document may be reviewed to determine if the document has a copyright notice. The document may be reviewed by a translator and/or by a computing device. If the computing device reviews the document and finds a copyright notice, then a notification may be provided to an administrator and/or translator for assessment of the copyright issue. Alternatively, if the translator finds the copyright notice, the translator may assess and address the copyright issues. However, as is known, the presence or absences of a copyright notice is not dispositive of all copyright issues.

When a copyright issue arises a determination is made whether or not the document may be translated without violating the copyright notification. As shown in step 18, a determination that the document cannot be translated due to copyright protection disables the use of the electronic document. The disabling of the document may be done manually by the translator or automatically by the computing device. By disabling the electronic document, an incomplete notification is sent to the client indicating that the document submitted is copyright protected and a translation cannot be completed. However, a determination that the document may be translated enables the method 10 to continue at step 20.

In step 20, a working template is created from the electronic document using the computing device. Step 22 displays the working template on a user interface connected to the computing device. The working template includes at least one original document section and a translation section corresponding to each of the at least one original document sections. For example, the original document section may be an Adobe® or similar document and the translation section may be a word processing document, but other document types could also be used.

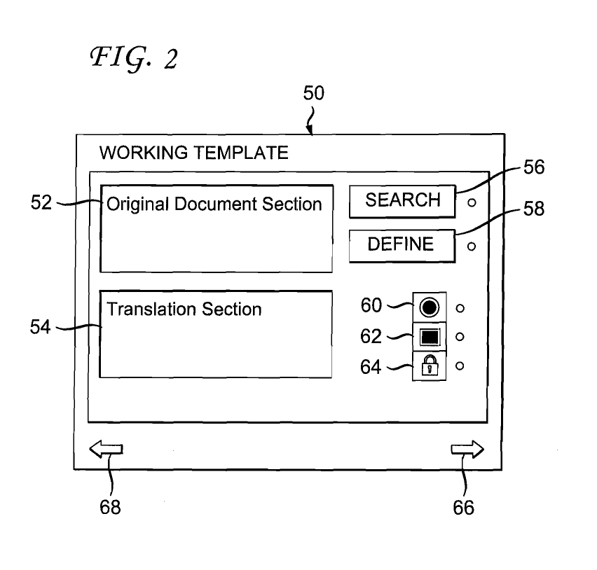

The original document section contains a portion of the electronic document. The translation section contains a blank text box configured to receive the translated text. FIG. 2 provides an example and further details of the working template.

Next, in step 24, one or more translation actions are performed using the working template. The translation actions are selected from the group consisting of: searching the original document section for all industrial terminologies; inserting, in the translation section, a definition as a representation of each industrial terminology; searching the original document section for all terms of art in the original document section; and inserting, in the translation section, a plain English representation of each of the terms of art. The plain English translation of the terms of art may be selected from a custom automatic correction database or a pre-existing database with plain English synonyms.

After the translation actions are performed, step 26 provides for the selection of one custom icon from a set of custom icons that symbolizes the translation action performed. The selection of the custom icon symbolizing the translation action may occur after each original document section is translated, after all original document sections are translated, or at any point after at least one translation action is performed.

In Step 28, the plain English guide is produced using the computing device to generate a report. The report contains at least one original document section adjacent to the at least one translation section with a custom icon adjacent to each pair of original document and translation sections. Step 30 provides the optional feature of saving the plain English guide as an archived document. Finally, the plain English guide is sent to the customer in step 32. The plain English guide may be sent to the customer with a cover letter. The plain English guide may be sent electronically (i.e., via email), mailed, faxed, or delivered using any other delivery method.

FIG. 2 provides an example of one embodiment of a working template 50. As previously stated, the working template contains two sections, the original document section 52 and the translation section 54. The original document section 52 contains a portion of the electronic document. The portion of the electronic document may be designated as any logical portion of the electronic document. For example, one of the original document sections 52 may be created for each paragraph of the electronic document.

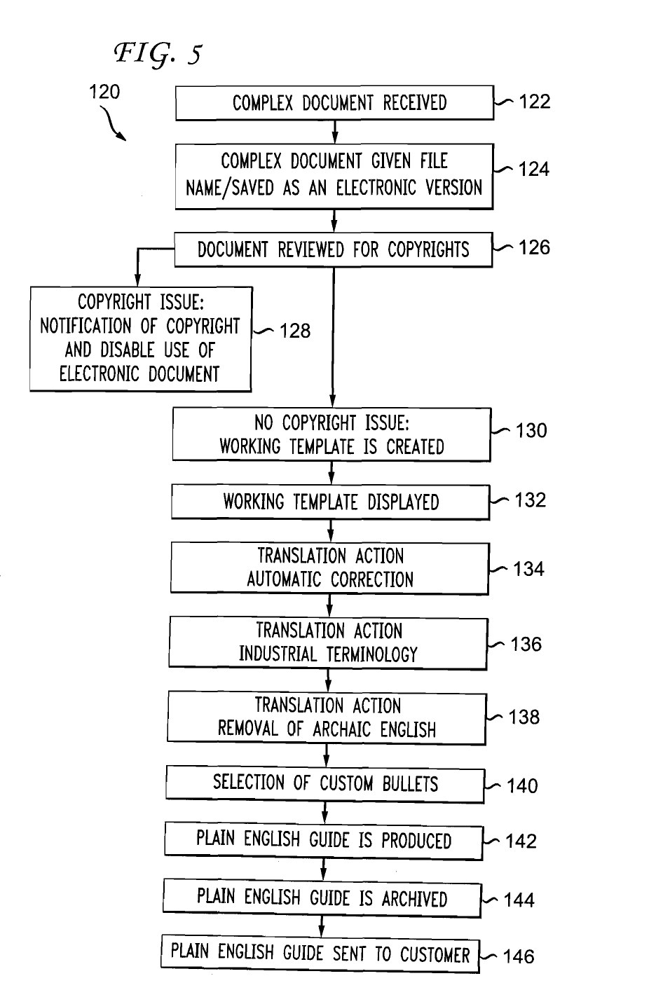

The original document section 52 may include a search 56 and a define 58 function. The search 56 and define 58 functions were previously described above at step 24 of the method 10 of FIG. 1 and are further discussed in steps 134, 136, and 138 of the method 120 of FIG. 5.

The working template 50 may further include a set of custom icons 60, 62, 64. The custom icons symbolize the translation action performed in each translation section 52. For example, the icons 60, 62, 64 shown in FIG. 2 are as follows. A circle 60 represents an Alert that the information in the translation section 54 needs further clarification from an attorney or document preparer. A square 62 represents no translation was performed in the translation section 54 because the document language is clear. An open lock 64 represents a portion of the document that the translation actions were applied thereto using the method 10 described above.

The working template 50 may further include a next 66 option and a previous 68 option. The next 66 and previous 68 options enable the preparation of the translation section 54 for each original document sections 52 not yet prepared and enable a translator to review and/or edit the translation sections 54 previously prepared.

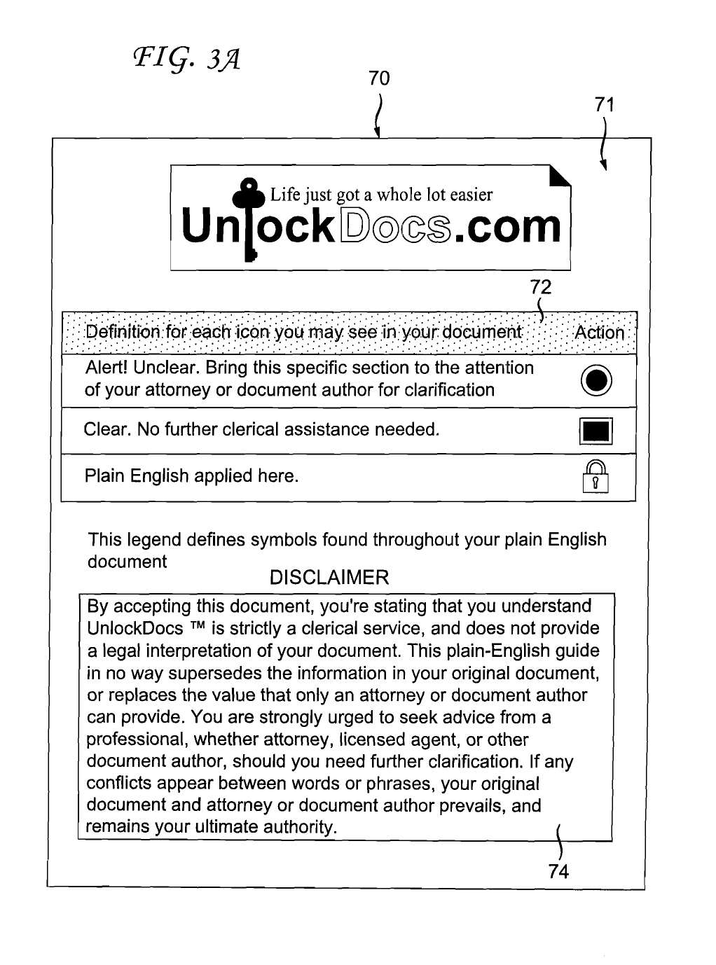

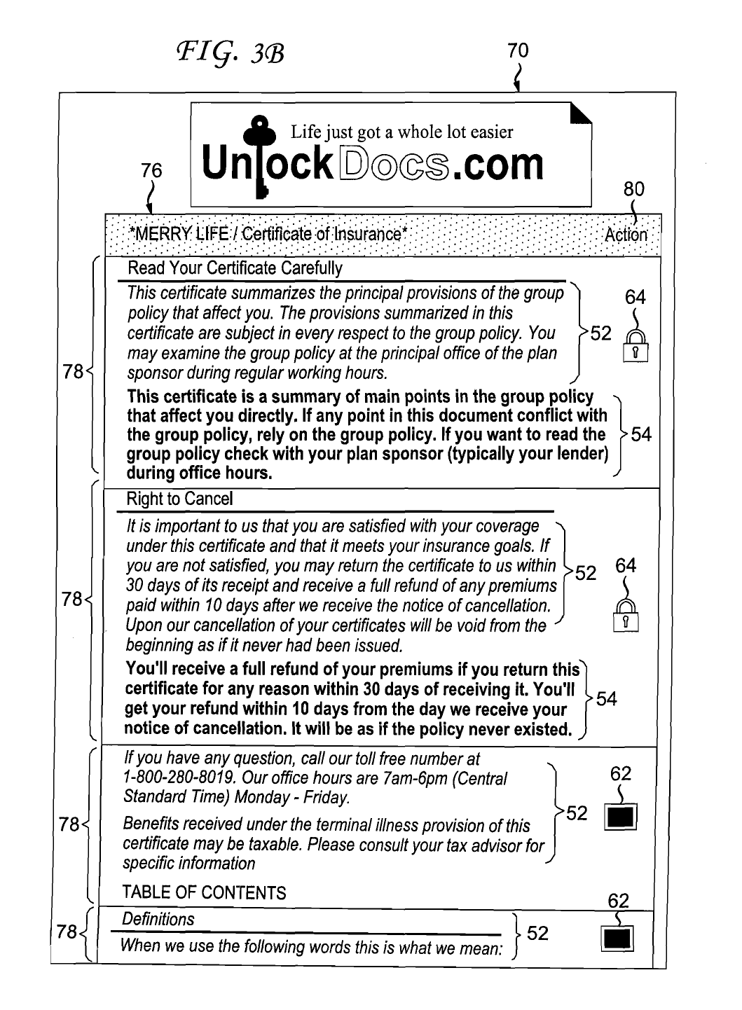

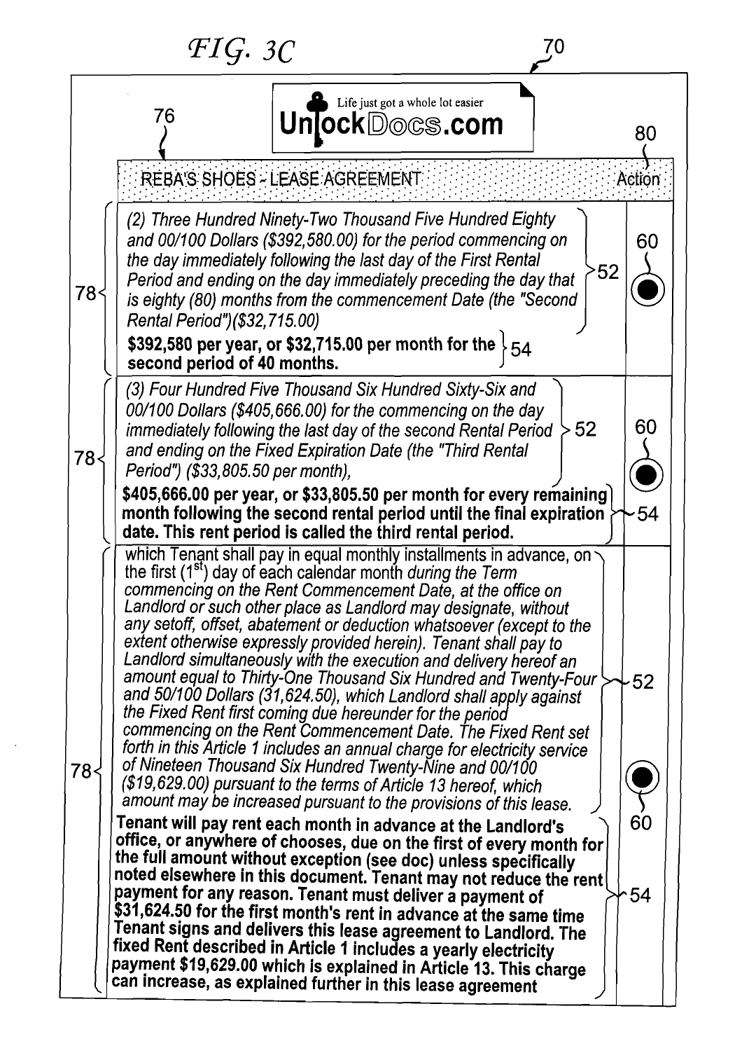

FIGS. 3A, 3B, and 3C provide an example of the plain English guide 70.

FIG. 3A provides a cover page 71 of the plain English guide 70 with definitions 72 of the translation actions and a disclaimer statement 74.

FIGS. 3B and 3C provide examples of subsequent pages of the plain English guide 70 containing a translation report 76. The report 76 is compiled from each of the working templates 50. For example, the combination 78 of the original document section 52 and the translation section 54 may be positioned adjacent to each other, as shown in FIGS. 3B and 3C. Specifically, FIGS. 3B and 3C show the report 76 with the original document section 52 positioned above the translation section 54. The report may further include a translation action symbol 80 adjacent to the original document section 52 and the translation section 54. For example, FIGS. 3B and 3C show the translation action symbol 80 on the right-hand side of the report 76 next to the corresponding combination 78 of the original document section 52 and the translation section 54.

With reference to the report 76 of FIG. 3B, the first two entries include the opened lock 64 translation action symbol 80, which indicates that the plain English translation has been provided. The second two entries include the square 62 translation action symbol 80, indicating that no translation was provided because the language of the original document section 52 was clear. The second two entries show the report as not having a translation section 54 since the translation section 54 of the working template remains blank when the language is clear in the original document. This typically occurs when the text of the electronic document contains section breaks or headings.

FIG. 3C provides an example of the report 76 with the circle 60 translation action symbol 80. When the circle 60 translation action symbol 80 is on the report 76, the information in the translation section 54 does not provide a full plain English translation of the electronic document. The circle 60 indicates to the customer that that portion of the electronic document needs to be clarified and/or discussed with the attorney or document preparer.

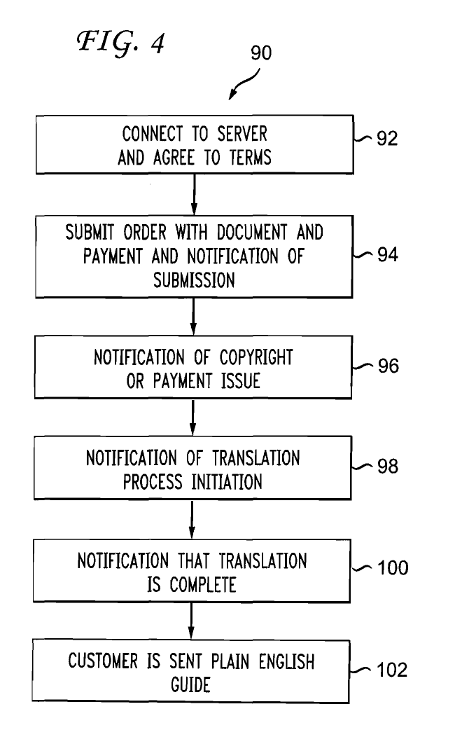

FIG. 4 provides an example of a customer's view of a method 90 for obtaining a translated document. The customer initially connects to a secure server and agrees to the terms of use in step 92. Then, in step 94 the customer submits an order containing an electronic document and payment. After that, in step 96, the customer is notified of any pre-translation issues, such as a copyright issue or a payment issue. For example, the customer may also be notified of any adjustments to the pricing of the document due to changing the font size to conform. Moreover, any additional problems with the document may also be addressed with a notification. For example, a notification may be sent when the document is improperly received due to an uploading error, unknown file extension or file name error, and/or an illegible document due to poor scanning. When an adjustment is necessary, the customer may be required to accept the adjustment prior to performance of the translation.

Next, in step 98, the customer is notified that the order is assigned to a translator and the translation method 10 as described above is being performed. Step 100 provides notice to the customer that the translation is completed and that the plain English guide has been completed. In step 102, the customer receives the plain English guide containing the cover letter, with definitions of translation actions and a disclaimer, and the report with the translations and translation action symbols.

With reference to FIG. 5, a method 120 providing a further embodiment of the method 10 of FIG. 1 is shown. The method 120 uses computer software to automate steps of the method 10.

In step 122, a complex document is received by a computing device configured to perform document translation. It is preferred that the complex document is submitted and received by the computing device electronically using a secure connection that requires clients to login via a web portal. However, the complex document may be received via email or by any other electronic means as may be appreciated by one skilled in the art. Then, the complex document may be given a file name and/or saved as an electronic document to a server, database or computing device, in step 124.

Next, in step 126 the document may be reviewed to determine if the document has a copyright notice. The document may be reviewed by a translator and/or by a computing device. If the computing device reviews the document and finds a copyright notice, then a notification may be provided to an administrator and/or translator for assessment of the copyright issue. Alternatively, if the translator finds the copyright notice, the translator may assess and address the copyright issues.

When a copyright issue arises, a determination is made whether or not the document may be translated without violating the copyright notification. As shown in step 128, a determination that the document cannot be translated due to copyright protection disables the use of the electronic document. The disabling of the document may be done manually by the translator or automatically by the computing device. By disabling the electronic document, an incomplete notification is sent to the client indicating that the document submitted is copyright protected and a translation cannot be completed. However, a determination that the document may be translated enables the method 120 to continue at step 130.

In step 130, a translation wizard on the computing device creates a working template from the electronic document. Step 132 displays the working template on a user interface connected to the computing device. The working template includes at least one original document section and a translation section corresponding to each of the at least one original document sections. The working template may include a split screen view of the original document section and the translation section. For example, the original document section may be an Adobe® or similar document and the translation section may be a word processing document, but other document types could also be used.

The original document section contains a portion of the electronic document. The original document section may be shown as a snapshot of a portion of the electronic document. The translation section contains a blank text box appearing as a window and configured to receive the translated text.

Next, in steps 134, 136, and 138, one or more translation actions are performed using the working template. In step 134 an automatic correction and/or search and replace function is used to change basic words of the electronic document. For example, the search and replace function may be used when the name of the party is desired instead of a generic term, i.e., the word borrower may be searched for and replaced with the name of the borrower in the translation section. An example of the automatic correction function is that each time the word “therefore” is typed in the translation section, the computer may replace the word “therefore,” with the word “so.”

In step 136, the translation wizard searches the original document section for all industrial terminologies and then inserts in the translation section, a definition as a representation of each industrial terminology. The definition is determined based on a dictionary that is specific to the industry of the electronic document. The definitions may be automatically inserted similar to step 134, but only if a specific industry is identified prior to performing the translation.

Step 138 removes archaic English and tightens the grammar of the translation section. The translation wizard searches the original document section for all terms of art in the original document section and inserts, in the translation section, a plain English representation of each of the terms of art. The translation wizard may also provide for automatic correction of archaic English in the translation section. The plain English translation of the terms of art may be selected from a custom automatic correction database or a pre-existing database with plain English synonyms.

After the translation actions are performed, step 140 provides for the selection of one custom icon from a set of custom icons that symbolizes the translation action performed. The selection of the custom icon symbolizing the translation action may occur after each original document section is translated, after all original document sections are translated, or at any point after at least on translation action is performed.

In Step 142, the plain English guide, as shown in FIGS. 3A, 3B, and 3C, is produced using the computing device to generate a translation report. The report contains at least one original document section adjacent to the at least one translation section with a custom icon adjacent to each pair of original document and translation sections. Step 144 provides the optional feature of saving the plain English guide as an archived document. Finally, the plain English guide is sent to the customer in step 146. The plain English guide may be sent to the customer with a cover letter and may be sent electronically (i.e., via email), mailed, faxed, or delivered using any other delivery method.

A number of embodiments of the invention have been described. Nevertheless, it will be understood that various modifications may be made without departing from the spirit and scope of the invention. Accordingly, alternative embodiments are within the scope of the following claims.

What is claimed is:

1. A method for building a plain English guide containing translations of a complex document comprising:
creating a working template from an electronic copy of said complex document using a computing device, wherein said template includes at least one original document section and a translation section corresponding to each of said at least one original document sections, said original document section containing a portion of said complex document, said translation section containing a blank text box;
displaying said working template on a user interface connected to said computing device;
performing one or more translation actions, said translation actions selected from the group consisting of:
searching said original document section for all industrial terminologies in said original document section;
inserting, in said translation section, a definition as a representation of each of said industrial terminologies;
searching said original document section for all terms of art in said original document section; and
inserting, in said translation section, a plain English representation of each of said terms of art;
selecting one of a set of custom icons after performing each of said translation actions, said custom icons symbolizing said translation action performed; and
producing said plain English guide using said computing device to generate a report containing said at least one original document section adjacent to said at least one translation section and arranging said custom icon adjacent to each pair of said original document and translation sections.

2. The method of claim 1, further comprising the step of receiving said complex document for translation.

3. The method of claim 2, wherein said step of receiving further includes submitting said complex document to said computing device electronically using a secure connection that requires clients to login via a web portal.

4. The method of claim 2, further comprising the step of saving said complex document to a server operatively connected to said computing device.

5. The method of claim 2, further comprising the step of sending a customer submission notification after said complex document is received.

6. The method of claim 1, wherein said set of custom icons include: an alert icon, a plain English icon, and a no action icon.

7. The method of claim 1, further comprising the step of saving a copy of said plain English guide to an archive database.

8. The method of claim 1, further comprising the step of electronically sending said plain English guide to a client.

9. The method of claim 1, further comprising the step of providing a notification when said complex document contains a copyright notice.

10. The method of claim 9, wherein said step of providing a notification includes disabling the performance of translation actions in said original document section containing said copyright notice.

11. The method of claim 1, wherein said step of searching said original document section is done using a search function incorporated in said computing device.

12. The method of claim 1, wherein said steps of inserting each representation of said terms of art and inserting said definitions representations further includes using a replace function incorporated in said computing device.

13. The method of claim 1, wherein each of said original document sections contain a single paragraph of said complex document.

14. The method of claim 1, wherein said step of performing said one or more translation action further comprising replacing automatically each of said terms of the art in said translation section with said plain English word corresponding to said terms of the art using an automatic correction function.

15. The method of claim 1, further comprising the step of sending a translation notification to a customer at an initiation of said performance of said one or more translation function.

16. The method of claim 1, further comprising the step of sending a completion notification to a when said plain English guide is produced.

17. The method of claim 1, wherein said creating step includes providing said working template in a split screen view of said original document section as an Adobe® document window and said translation section as a word processing document window.
